(19) United States
(12) Patent Application Publication
(10) Pub. No.: US 2025/0122736 A1
(43) Pub. Date: Apr. 17, 2025

(54) Advanced Roof Platform

(71) Applicants: Michael James Mastalir, Whitefish Bay, WI (US); Robert James Manganelli, Easton, MD (US)

(72) Inventors: Michael James Mastalir, Whitefish Bay, WI (US); Robert James Manganelli, Easton, MD (US)

(21) Appl. No.: 18/977,527

(22) Filed: Dec. 11, 2024

Related U.S. Application Data
(63) Continuation-in-part of application No. 18/449,906, filed on Aug. 15, 2023.

(51) Int. Cl. E04G 3/26; E04G 5/04

(52) U.S. Cl. CPC E04G 3/265; E04G 5/041

(57) ABSTRACT

A portable, handheld system designed for anchoring and securing ladders, pump jack scaffolding, and walkways on pitched roofs or inclined surfaces. The invention includes three platform configurations, each with a variable pitch adjustment for leveling across multiple roof angles: (1) a ladder stop platform equipped with a 360-degree stop mechanism for multi-directional ladder stabilization; (2) a pump jack platform that provides a stable base for supporting pump jack systems and scaffolding; and (3) a walkway platform configured with parallel plank attachment bars and integrated guardrails for safe foot traffic. Each platform features anchor beds for secure attachment to structural elements like roof trusses and reinforced lateral rib members for uniform load distribution, enhancing structural integrity and load-bearing capacity across the system.

### CROSS REFERENCE TO RELATED APPLICATION

This application is a Continuation-in-Part (CIP) of U.S. Non-Provisional Utility patent application Ser. No. 18/449,906, filed on Aug. 15, 2023, titled “Rooftop Platform—SafetyPitch,” which claims the benefit of and priority to U.S. Provisional Patent Application No. 63/454,615, filed on Mar. 24, 2023, titled “Rooftop Platform—SafetyPitch.” The entire disclosures of both the prior non-provisional and provisional applications are incorporated herein by reference in their entirety. The applicant claims the benefit of the filing dates of these prior applications in accordance with 35 U.S.C. § 120, 37 C.F.R. § 1.78, and 35 U.S.C. § 119(e) [R-07.2015].

The present Continuation-in-Part (CIP) application claims priority to, and incorporates by reference, the disclosures set forth in the original non-provisional “parent” application titled: “Rooftop Platform—Safety Pitch.” This CIP expands and refines the scope of the parent application by delineating three distinct derivative embodiments, each specifically tailored for specialized anchoring and support on pitched roof surfaces or inclined work environments.

The present disclosure's novelty lies in the specific arrangement and integration of its components, creating a portable, adaptable platform that serves multiple utilities. In each configuration, a stable, level base is achieved through an adjustable platform directly secured to roof trusses or similar support structures. This system provides a reliable foundation for ladders, pump jacks, and walkways on roofs or similar, inclined surfaces, accommodating various construction needs. The unique combination of elements can offer a new and non-obvious solution, effectively addressing the challenges of stability, versatility, and portability in roofing, siding, and cladding applications.

Whereas the original invention, the 360 degree, ladder stop, pump jack, and walking plank configurations were integrated into a unified platform. The present CIP separates these components into three discrete, stand-alone configurations:
(1). Ladder Stop Configuration: builds upon the platform disclosed in the parent application, retaining the core structural elements such as the trust-centric, support framework and pitch-adjustable features. However, through a reductive process, the pump jack and walking plank configurations are eliminated, allowing the ladder stop to specialize in anchoring the ladder securely on pitched roofs. This focused adaptation preserves the parent application's platform and pitch configurations while streamlining the design to enhance ladder safety and stability. The result is a derivative, specialized embodiment of the original invention, optimized for its specific function.
(2). Pump Jack Configuration: The portable, pump jack platform configuration emerges through a reductive process, where non-essential features from the parent application are removed to concentrate on pump jack-specific utility. This streamlined approach preserves the essential structural components necessary for truss-based stability and load distribution while enhancing functionality tailored to pitched roof scaffolding. This reductive evolution demonstrates the platform's progression into a specialized yet derivative iteration of the original invention.
(3). Platform Configuration: builds upon the platform disclosed in the parent application, retaining the core structural elements such as the trust-centric, support framework and pitch-adjustable features. The ladder stop and pump jack configurations are eliminated, enabling the platform to specialize in supporting walking surfaces and guardrails. This embodiment focuses exclusively on providing a stable, safe surface for foot traffic on inclined work areas. The result is a derivative and specialized version of the original invention, optimized for walkway-specific function.

Each of these derivative embodiments is distinctly developed, providing for their design parameters and intended uses to be explicitly addressed while advancing the functionalities established in the parent application. The separation of configurations allows for specialized performance enhancements in line with applicable safety standards, offering practical solutions for secure and adaptable work on sloped surfaces.

### FIELD OF THE INVENTION

The present disclosure introduces new embodiments that can further enhance the safety, security, and efficiency of systems designed to anchor: (1) ladders (2) pump jack scaffolding systems, and (3) walkways on pitched roofs and other inclined structures. These improvements are distinct from the Parent, non. provisional application (Rooftop Platform—SafetyPitch), which combines all utilities into a singular system. By presenting these utilities individually, they are applicable to a wide range of industries, both residential and commercial, with particular relevance to roofing, siding, and cladding sectors. These systems are adaptable for the installation and maintenance of various materials, including but not limited to asphalt, metal, wood, vinyl, brick, stone, and composite materials.

The present disclosure also finds applications in set construction and rigging for media, film-television and live entertainment operations. By providing horizontally level platforms for anchoring ladders, pump jacks, walking platforms, and other equipment. The present disclosure addresses the specific challenges of working on pitched roofs and inclined surfaces. Its adoption within these industries can significantly enhance safety and productivity in roofing and siding installation, construction, restoration, maintenance and repair that is performed on inclined surfaces.

Set building for film, television, theater, and concerts often requires working with unconventional pitch configurations and angles. The present disclosure addresses these challenges with a level base and a 360-degree pump jack housing, allowing scaffolding to be positioned in any direction. This circular design enables pump jack scaffolding at dramatic diagonals that conventional (square), right-angled housings cannot achieve, supporting builds that present illusionary or forced depth perspectives for camera angles. Additionally, it offers 360-degree ladder sets, ensuring safe and efficient maneuverability in dynamic set construction environments.

### BACKGROUND OF INVENTION

The three utilities disclosed herein are designed to utilize roof truss support for mounting navigation systems in order to access and service architectural features such as dormers, cupolas, soffits, parapets, fascia, roof valleys, gables, chimney chases, and rooftops with integrated solar arrays. By anchoring directly to the roof trusses, the system facilitates the deployment of rooftop pump jack scaffolding, modular walking platforms, and ladder support mechanisms. This structural configuration can enable precise placement and secure anchorage on inclined surfaces, leveraging the inherent structural capacity of the roof trusses to provide a mechanically efficient solution for elevated work operations. The invention minimizes reliance on ground-based assemblies, enhancing focused stability and structural integration in specialized applications

The siding and cladding industry predominantly employs ground-based scaffolding configurations, which typically involve complex assembly, substantial material costs, and structural redundancy. The present invention introduces an alternative structural support system that utilizes a multi-tiered, pitched roof configuration as the primary load-bearing framework for pump-jack, scaffolding applications. This approach diverges from conventional ground-supported scaffolding by optimizing structural integration with the roof's geometry to accommodate various architectural features.

In addition to traditional siding and cladding applications, the rapid advancement in solar panel installations on rooftops necessitates the integration of both functional and aesthetic elements within complex multi-angular and multi-directional roofing schemes. This integration represents a significant opportunity for the widespread adoption of clean energy solutions.

To address the demands of advanced rooftop applications, there exists a critical need for specialized tools and equipment tailored for installation, maintenance, repair, and replacement tasks. The present disclosure offers omni-directional pump-jack assemblies and scaffolding configurations. These innovations are designed to optimize access and support the heightened rooftop traffic associated with the deployment of emerging clean energy technologies.

Given this constantly evolving market, technologies, and the expanding government policy environment, rooftop installations, replacement, maintenance, siding and cladding industry is poised to play a pivotal role in shaping and redefining the commercialization of clean energy within both commercial and residential sectors. The rooftop-siding/cladding industry will be at the forefront of defining and redefining the commercialization of clean energy within commercial and residential constructs

### Adherence to Regulatory Codes

This section addresses compliance with, or exceeding, regulatory standards applicable to ladder, pump-jack, and walkway anchoring systems when deployed on uneven or sloped surfaces. These standards are in addition to those outlined in the prior non-provisional parent application, to which this Continuation-in-Part (CIP) application claims priority and builds upon its disclosures.

The present embodiments are designed to comply with OSHA's revised fall protection regulations, specifically 29 CFR Part 1926, Subpart M, which establishes requirements for preventing falls from heights. The design integrates anchoring points and a robust, adjustable base to meet the safety standards for ladders, scaffolding and walkways as specified in OSHA directives. This emphasis on stability and load distribution can not only ensure compliance but also significantly enhances worker safety on inclined surfaces, aligning with OSHA's current enforcement priorities. The engineering principles employed facilitate effective load management and mitigate risks associated with elevated work environments, reinforcing the overall safety framework mandated by OSHA.

OSHA1926.452(g)(3): “When extended for use, folding-type metal brackets must be secured with a locking-type pin or bolted.”

OSHA 1926.451(c)(2): “Supported scaffold poles, legs, posts, frames, and uprights must rest on base plates and mud sills or other suitable firm foundations. Footings must be level, sound, rigid, and capable of supporting the scaffold's load without settling or shifting.”

OSHA 1926.451(c)(2)(iv): “Scaffolds and platform units must not be supported by unstable objects such as barrels, boxes, loose bricks, or concrete blocks.”

OSHA 1926.451(b)(1): “The platform must be fully planked or decked to provide a continuous, stable working surface.”

California Title 8, Section 1655: “Pump jack scaffolds must be erected on a sound, level, and firm base, such as a mud sill or equivalent foundation, to prevent shifting or settling under load. Proper bracing is essential for stability, particularly as scaffold height increases. Scaffold poles must be secured to the work wall using rigid triangular bracing or equivalent at the bottom, top, and at intervals not exceeding 10 feet. Each brace must support at least 225 pounds of tension or compression.”

ANSI/ASSE A10.8-2011: “Scaffolds, including pump jack systems, must be erected on a sound, level, and firm base capable of supporting the intended load without shifting, settling, or failure. Proper bracing is crucial to maintain stability, especially as the scaffold is raised. This includes diagonal bracing and other supports to prevent tipping or collapse.”

Canadian Standards Association (CSA)—CSA Standard Z797-21: “Code of Practice for Access Scaffold” includes requirements for scaffolding stability and load-bearing considerations. Each province in Canada, such as Ontario and British Columbia, may have specific regulations or adaptations of these federal standards, which also outline similar requirements for scaffolding.

OSHA (U.S. Federal Standards) 29 CFR 1926.501(b)(11): For steep roofs (greater than 4:12 pitch), fall protection systems must be used. Options include guardrail systems, safety net systems, or personal fall arrest systems.

29 CFR 1926.502(b): Specifies the requirements for guardrail systems, including a top rail height of 42 inches (plus or minus 3 inches) and a mid-rail installed halfway between the top rail and the walking surface. The guardrail must withstand a force of at least 200 pounds

California Code of Regulations, Title 8: Section 1620: This section addresses guardrails and railings for construction sites, including the use of guardrails on roofs. Guardrails must be 42 inches high with mid-rails and toe boards if there are workers below. Guardrails must withstand 200 pounds of force.

Section 1632: Requires fall protection on elevated surfaces. On roofs steeper than 7:12 pitch, guardrails or other fall protection systems must be used.

Section 3212: Covers the general requirements for guardrails, including materials, height, strength, and installation on elevated work areas. CCOHS and Provincial Regulations (Part XII, Section 12.10): Fall protection must be provided when workers are exposed to a fall risk greater than 3 meters (approximately 10 feet). Guardrails must meet specific requirements for height and strength.

Ontario Regulation 213/91 (Construction Projects): Requires guardrails on walkways and work areas where there is a fall risk of more than 2.4 meters (about 8 feet). Guardrails should be at least 0.9 meters (35 inches) high and withstand 450 newtons (about 100 pounds) of force.

British Columbia OHS Regulation (Part 11): For roofing work, guardrails are required on roofs with a slope greater than 4:12 if workers are less than 2 meters from the edge.

### Drawbacks of Previous Inventions

The prior utility application (U.S. Non-Provisional Utility patent application Ser. No. 18/449,906, filed on Aug. 15, 2023, titled: “Rooftop Platform—SafetyPitch), presents an integrated solution that combined ladder stop, pump jack, and walking plank anchoring functionalities within a single platform. While this design meets or exceeded established regulatory load-bearing capacities, it also introduces several drawbacks that are addressed in the current Continuation-in-Part (CIP) disclosure.

Complex Load Distribution: The all-in-one design created challenges in load distribution, as the combined weight and operational loads from multiple functionalities could lead to potential overloading of specific components. Although the integrated platform is engineered to meet regulatory standards, the complexity of use increased the potential for user misuse, where operators may inadvertently exceed safe load limits.

Reduced Specialization: By merging multiple functionalities into one system, the prior design may compromise the specialization of each component. Each function—ladder stabilization, pump jack scaffolding, and walkway anchoring—has unique operational requirements and load capacities. The inability to tailor each component for its specific task could lead to suboptimal performance, particularly under variable field conditions encountered on sloped or uneven surfaces.

Operational Inefficiency: The integrated platform required users to deploy a single system for diverse tasks, resulting in complexity during setup and operation. Users were compelled to navigate multiple functionalities within one structure, which could lead to confusion and inefficiency, particularly in fast-paced construction environments.

Compromised Safety: While the load-bearing capacities of the prior invention comply with regulatory codes, the potential for simultaneous overload of the combined components could pose a safety risk. User misuse or misunderstanding of the operational limits could result in the platform not adequately supporting the cumulative commercial loads generated by simultaneous tasks. Although the original all-in-one configuration is still be suitable for homeowner applications, the commercial version warranted greater specificity to address these risks effectively.

The current CIP application addresses these drawbacks by delineating three distinct embodiments, each engineered for specific tasks associated with ladder stabilization, pump-jack scaffolding, and walkway anchoring.

Individual Load Capacity Compliance: Each embodiment adheres to its own defined load capacity requirements, thus enhancing safety and performance. This separation allows for optimized engineering solutions tailored to the specific operational needs of each component, significantly reducing the risk of overloading.

Improved Specialization and Functionality: By isolating functionalities, each embodiment can be designed and optimized independently. This specialization enables more effective responses to specific operational demands, ensuring that each system performs at its best under varying conditions.

Increased Operational Efficiency: The distinct embodiments facilitate simpler deployment and use, allowing workers to select the most appropriate system for the task at hand without the added complexity of an all-in-one solution. This not only streamlines operations but also enhances the user experience.

Overall: The transition from an integrated design to individual embodiments represents a salient improvement in both safety and operational efficacy, addressing the limitations of the prior invention while providing a more robust solution for construction activities on pitched roofs and inclined surfaces.

In yet another embodiment, the present disclosure incorporates a novel centered-adjustable pitch configuration that differs from its parent application in that the pitch bracket is secured by a bolt that runs the entire length of the pitch bracket, which is pin-locked to the tooth groove via a pin lock to an outer frame. This secure attachment allows for enhanced stability and precise adjustments to accommodate various roof pitches. It also adheres to OSHA regulatory code 1926.452(g)(3) that clearly states: “When extended for use, folding-type metal brackets must be secured with a locking-type pin or bolted.”

Additionally, the configuration includes a lower “L” bar attached to the bottom of the unit. This “L” bar features pre-drilled, wood screws that secure the unit to the roof trusses, providing dual anchorage at both the top and bottom of the assembly. By facilitating secure attachment points at both ends, this design improves load distribution and enhances the overall stability of the system.

Together, these features ensure that the assembly maintains structural integrity and complies with relevant safety standards while effectively supporting ladder, pump jack and walkway anchoring.

Traditional pump jack scaffolding configurations are anchored to the ground and can extend upward to the roof, encasing the roof but not directly attaching to it. In contrast, the present disclosure is designed to be directly set on and attached to the roof trusses, rather than relying on ground support. Placing the pump jack scaffolding on the roof allows for easy and efficient access to areas with siding on multi-gabled rooftop constructions. This roof-based attachment facilitates practical navigation across the rooftop, simplifying access and maneuverability. Consequently, it significantly enhances the efficiency of tasks such as siding or cladding installation.

U.S. Patent. No. US20030230451A1, issued to Garrett (Roofmates), demonstrates certain overlapping functionalities with the present invention. However, it lacks key features such as the 360-degree ladder stop and the omni-directional pump jack housing, and it is not designed for integration with walkway systems. Garrett's design confines pump jack pole positioning to a 180-degree range, whereas the current Continuation-in-Part (CIP) application introduces both square and round pump jack housings. This configuration enables versatile scaffolding solutions for traditional and unconventional applications, allowing erection at right angles and diagonals. As a result, the present invention enhances adaptability, improving scaffolding installations on pitched roofs or inclined surfaces.

Garrett's bolt-and-nut configurations are cumbersome, introduce additional tasks, and increase associated risks on rooftops.

Furthermore, Garrett's platform requires additional steps for adjusting various pitch settings, involving the engagement of nut and bolt connections.

### SUMMARY

The Continuation-in-Part (CIP) application builds upon the original non-provisional patent titled “Rooftop Platform—Safety Pitch” by introducing three distinct embodiments tailored for specific tasks related to ladder, pump jack, and walkway anchoring systems on pitched roofs or inclined surfaces. These embodiments enhance operational specificity and allow for improved load management, adhering to individual regulatory standards and mitigating risks associated with potential overload of combined components. The current invention incorporates a centered-adjustable pitch configuration, secured by a bolt that runs the length of the pitch bracket, along with an additional lower “L” bar with nail beds for securing the unit to roof trusses at both top and bottom. Furthermore, the CIP features both square and round pump jack housings, facilitating traditional and non-traditional scaffolding setups for right angles or diagonal applications. This approach significantly improves safety and efficiency during elevated work operations in various architectural contexts.

### BRIEF DESCRIPTION OF DRAWINGS

The present disclosure starts with an overall illustration in FIG. 1, which depicts the parent invention for reference. This inclusion provides the examiner with a basis for comparison, allowing a clear lineage of how the invention has evolved. Subsequent figures illustrate the additional features and modifications that distinguish the current Continuation-in-Part (CIP) application, demonstrating the product's development from the original design.

FIG. 1 is an overall view of the parent invention depicting its various components: (1) Nail beds to nail the invention to a roof or pitched structure. (2) Handle for carrying the platform. (3) 360-degree ladder stop with a non-slip membrane to provide secure ladder placement. (4) Pump jack housing for the hydraulic system. (5) Upper platform with 360 degree ladder stop. (6) Wood screw holes to secure the walking plank in place. (7) Walking plank housing to accommodate the walking plank. (8) Tie-down strap and drainage slot for securing the platform and allowing water drainage. (9) Lower support platform for stability. (10) Adjustable pivot linkage bracket for adjusting the platform's angle. (11) Adjustable pivot linkage crossbar that connects to the pivot linkage bracket. (12) Roof bracket mechanism embodying notches that capture and secure the pivot bracket crossbar. (13) Heavy-duty retainer ring for securing the components. (14) Adjustable pivot bracket base to provide a stable base for the pivot linkage bracket.

Please note: The primary component modifications that facilitated the evolution of the three derivative configurations are identified in FIG. 1, specifically in the following elements: (4) the pump jack housing, (7) the walking plank housing, (11) the crossbar connecting the pivot-linkage bracket, and (12) the roof bracket mechanism. These components serve as embodiments that directly inspire the development of the distinct utilities within the Continuation-in-Part (CIP) application.

FIG. 2 illustrates the following structural modifications: (1) a stand-alone 360-degree ladder stop assembly, absent the pump jack configuration; (2) an outer frame adapted to receive a steel crossbar; (3) a crossbar-to-bolt locking system featuring a pin-secured mechanism for enhanced stability; and (4) an auxiliary “L” bar attachment designed for secure engagement with standard truss structures.

FIG. 3 presents the stand-alone pump jack configuration, featuring the following key elements: (1) a pump jack housing that can accommodate either a square shape for right-angle applications or a circular shape for 360-degree positioning; (2) the platform; (3) wood screw housings designed for securing walking planks or walkways; (4) a cleat arrangement to provide additional stabilization for walkways; (5) an I-frame assembly incorporating upper and lower “L” bars for attachment to roof trusses; (6) a bolt locking point; (7) a variable pitch adjustment mechanism; and (8) teardrop-shaped wood screw openings located on both the upper and lower “L” bars of the I-frame, enabling secure attachment to trusses.

FIG. 4 presents an exploded view that delineates the individual components of the assembly, configured as a standalone system expressly designed for pump jack functionality. This illustration builds upon the pump jack components illustrated in FIG. 1, segregating and emphasizing critical features, including the I-frame structure (1), pin lock mechanism, adjustable pitch configuration (2), platform assembly (3), and walkway securing embodiments (4). Each component is depicted to elucidate its structural and functional interrelationships within the overall assembly.

FIG. 5 illustrates the pump-jack, I Frame base assembly.

FIG. 6 illustrates a squared, pump jack housing configured for a 180-degree right-angle pump jack scaffolding configuration.

FIG. 7 illustrates a circular, 360 degree pump jack housing for omni directional pump jack scaffolding configurations.

FIG. 8 presents an overall view of the pump jack system, illustrating the combined components as a unified configuration of the apparatus.

FIG. 9 illustrates a walkway configuration comprising two portable platforms, with the capability to accommodate two or more units. Each embodiment includes a platform that supports the attachment of walking planks or walkway assemblies and features an integrated guardrail system. This platform configuration is established in earlier figures, demonstrating its compatibility within the overall assembly. The key components are as follows: (1) Walkway Securing Configuration: Incorporates pre-drilled wood screw holes for the secure attachment of planks or walkway assemblies, enhanced by integrated cleat attachment mechanisms; (2) Lower Wood Screw Bed: Specifically designed for secure attachment to trusses; (3) Scaffolding Guardrail Base Shoes: Provides stable support for guardrail structures; (4) Pre-Drilled Holes for Guardrail Integration: Enables the secure attachment of guardrails to the platform; (5) Guardrail System: Establishes a protective barrier during operation.

### DETAILED DESCRIPTION OF INVENTION

### 360-Degree Ladder Stop

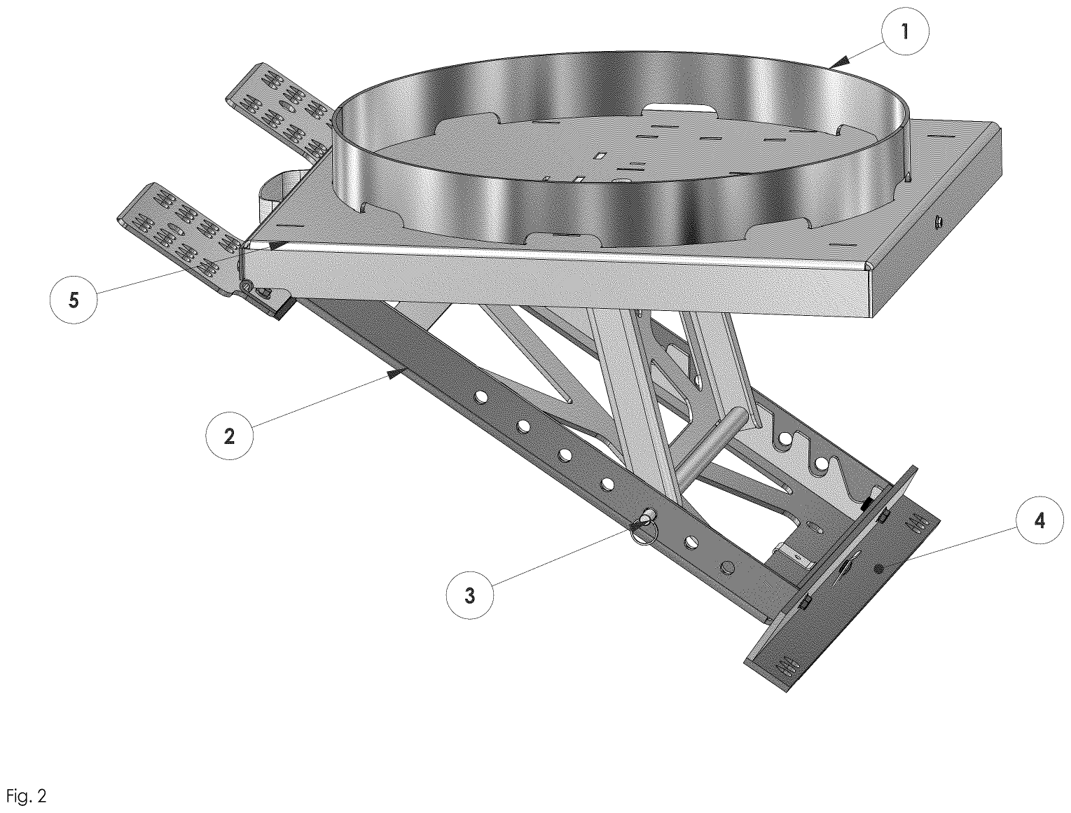

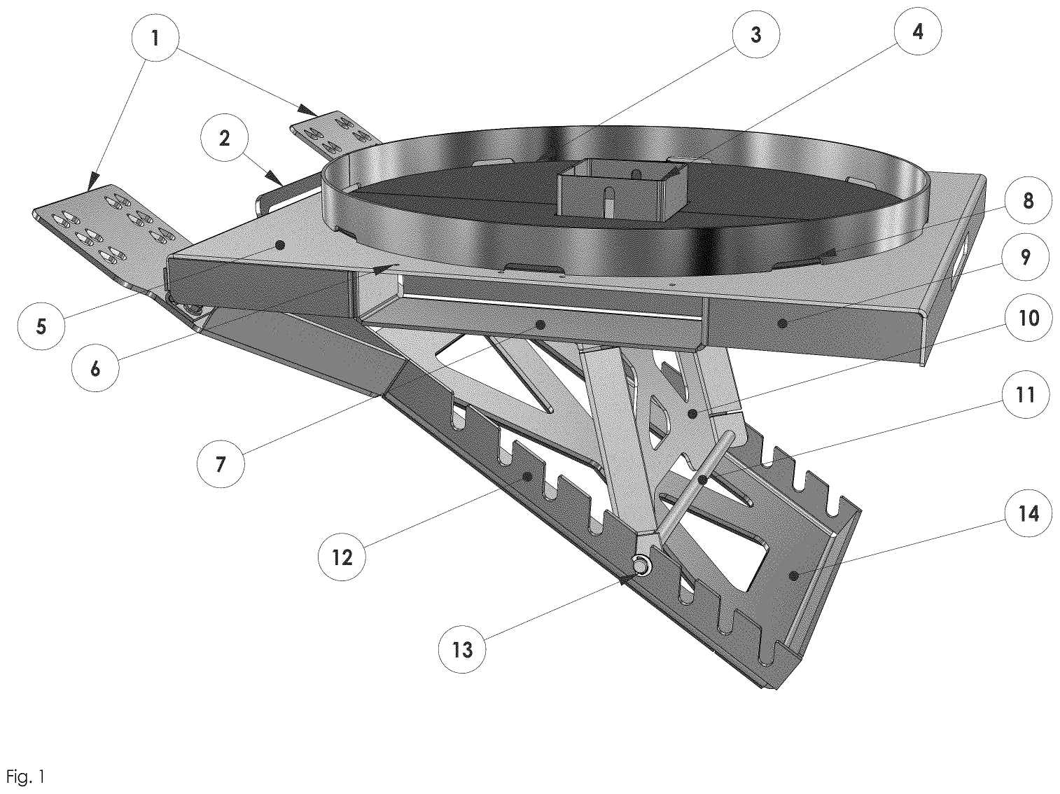

The present, CIP embodiment removes the pump jack configuration in FIG. 1(4) and the sleeved housings FIG. 1(7), from its parent “Roof Platform—SafetyPitch” non-provisional application, while retaining the core conceptual framework. Modifications include the addition of a lower “L” bar FIG. 2(4), which functions as an auxiliary truss-mounting element, with pre-drilled teardrop wood screw holes, enhancing structural stability and attachment to the truss system.

Additionally, the assembly incorporates an outer frame featuring a bolt and pin locking system, as illustrated in FIG. 2(2) and FIG. 2(3). In FIG. 2(3), a crossbar extends across the full width of the apparatus, aligning with the tooth grooves. This bar is positioned and secured in place using the pin locking mechanism, ensuring stability and reliability.

### Pump Jack Configuration

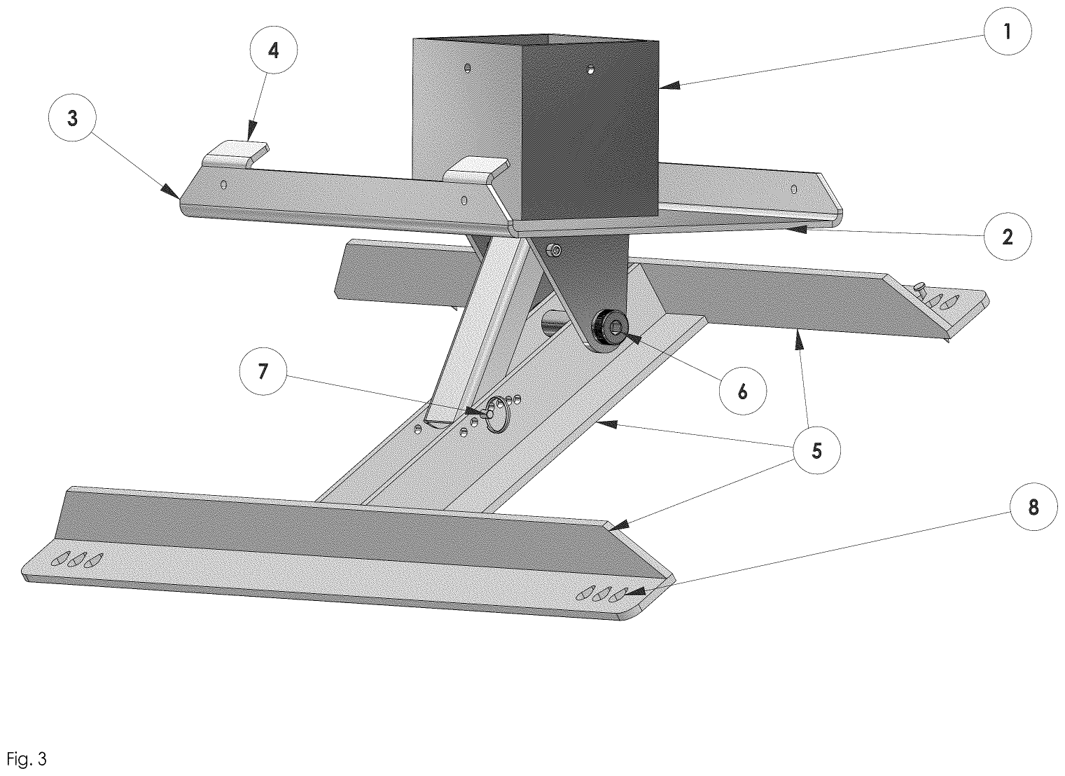

FIG. 3 illustrates the overall pump jack configuration. The present disclosure incorporates a platform configuration with reduced surface area, tailored to enhance load capacity. By optimizing load distribution and material strength, this configuration minimizes flex and maximizes stability under varying load conditions (static and dynamic).

Platforms with smaller surface areas distribute the load more effectively onto fewer points of contact with the supporting structure, such as roof trusses, allowing for greater efficiency and reliability. This design ensures that the pump jack system maintains structural integrity while accommodating the demands of different jack-pump scaffolding applications. Overall, the tailored platform's characteristics contribute to improved performance in pump jack operations.

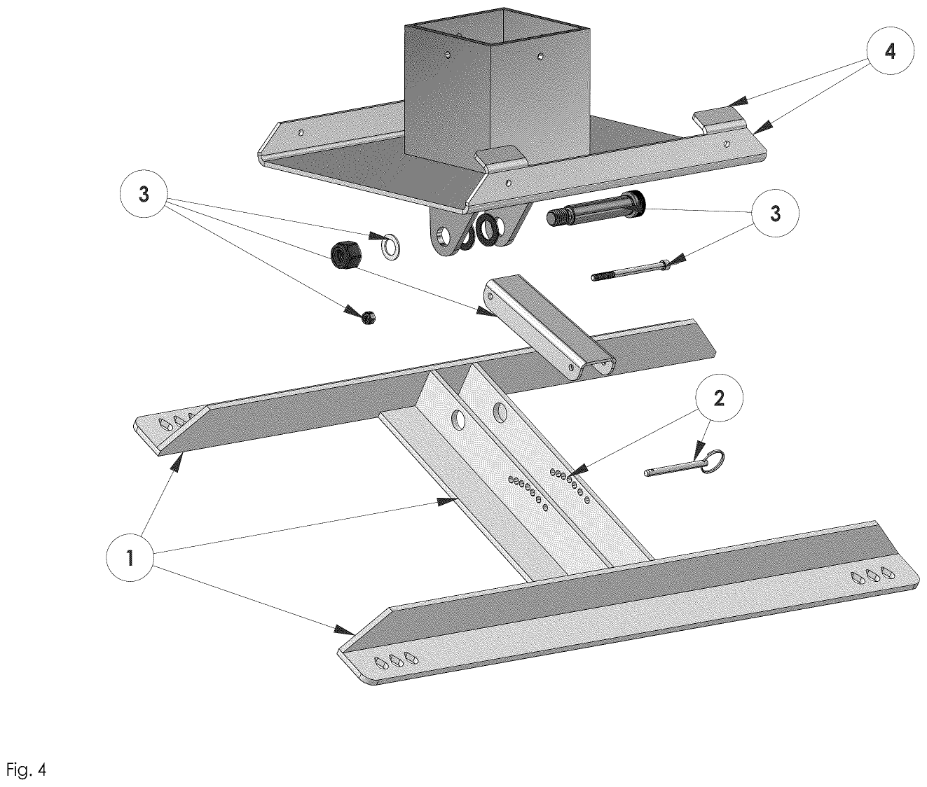

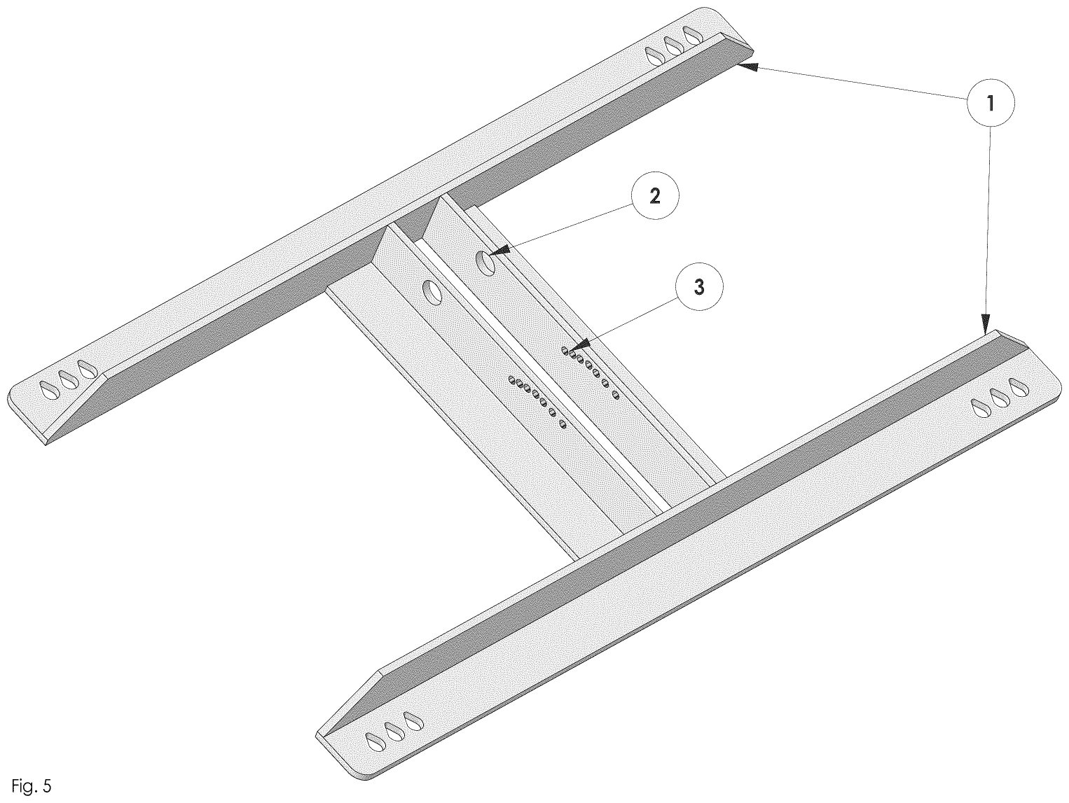

The “I-frame” base assembly comprises upper and lower “L” bars, FIG. 5(1), which are integrated with a vertical pitch bracket housing, as shown in FIG. 3(5) and FIG. 4(1). The horizontal members form the mounting structure of the I-frame, each featuring teardrop-shaped wood screw holes, FIG. 3(8), specifically sized to allow secure fastening to standard truss spacings, accommodating typical intervals such as but not limited to, 16-inch and 24-inch.

Pitch Bracket Configuration: The pitch bracket mechanism, FIG. 3(7), is integrated into the vertical-central portion of the “I-frame,” FIG. 3(5), FIG. 4(2), providing multiple selectable angle settings for precise leveling of the platform FIG. 3(2).

Locking Mechanisms: The pitch bracket is secured by an upper bolt lock, as shown in FIG. 3(6), FIG. 4(3), and FIG. 5(2), which functions as a static locking mechanism to maintain the bracket's fixed position. A lower pin lock, located at the lower section, FIG. 3(7), FIG. 4(2), and FIG. 5(3), act as a pitch-specific locking system, designed to engage and retain the selected angle, thereby keeping the pitch bracket stationary during use. Together, these locking components enhance the structural integrity and adaptability of the pump jack assembly, providing a stable and adjustable base for various pitch configurations.

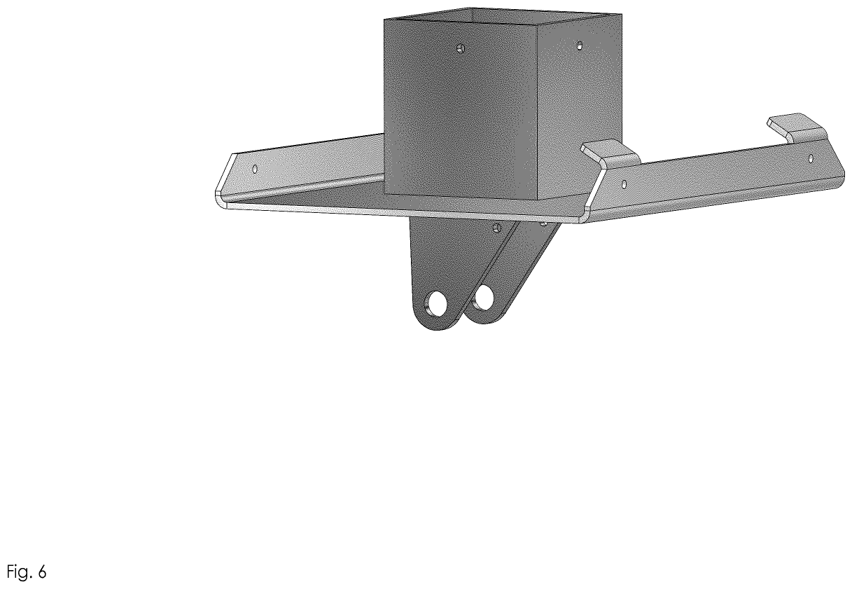

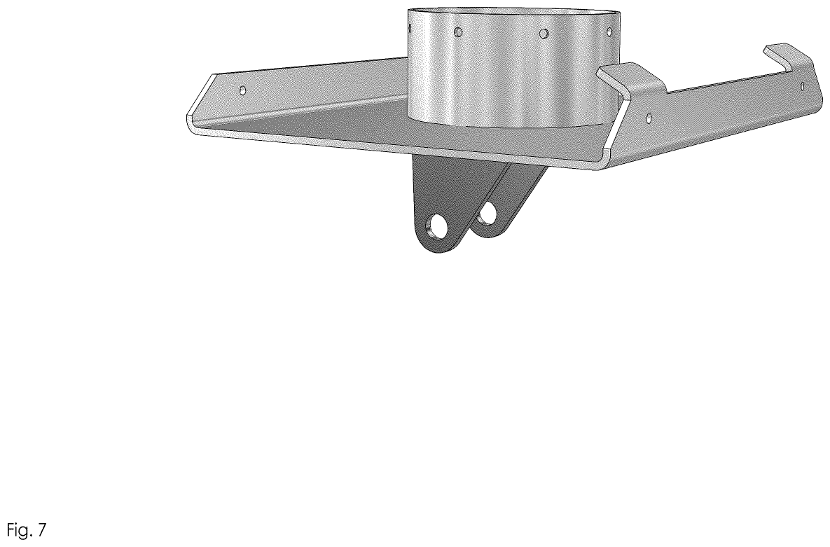

The platform provides a stable and level base for attaching walking planks or other walkway systems, using side-mounted wood screws and upper cleats, as shown in FIG. 4(4), to maintain stability. It also serves as a mounting point for the pump jack pole, securing it to the base as illustrated in FIGS. 6 and 7.

FIGS. 6 and 3(1) depict the square-shaped, 180-degree right-angle attachment housing used for securing the pump jack pole, which is traditionally configured to maintain the scaffolding at right angles to the facade. This arrangement suits standard construction surfaces but lacks the versatility required for architectural designs with diagonal facades that demand more flexible scaffolding alignments

FIG. 7 depicts the circular, 360-degree interchangeable pump jack pole attachment housing, designed to permit the pump jack pole to be positioned in any orientation. This novel configuration allows the scaffolding system to align parallel to diagonal architectural surfaces. Conventional scaffolding structures are typically arranged at right angles, but architectural designs with diagonal facades necessitate diagonal scaffolding alignments to maintain parallelism with the work surface.

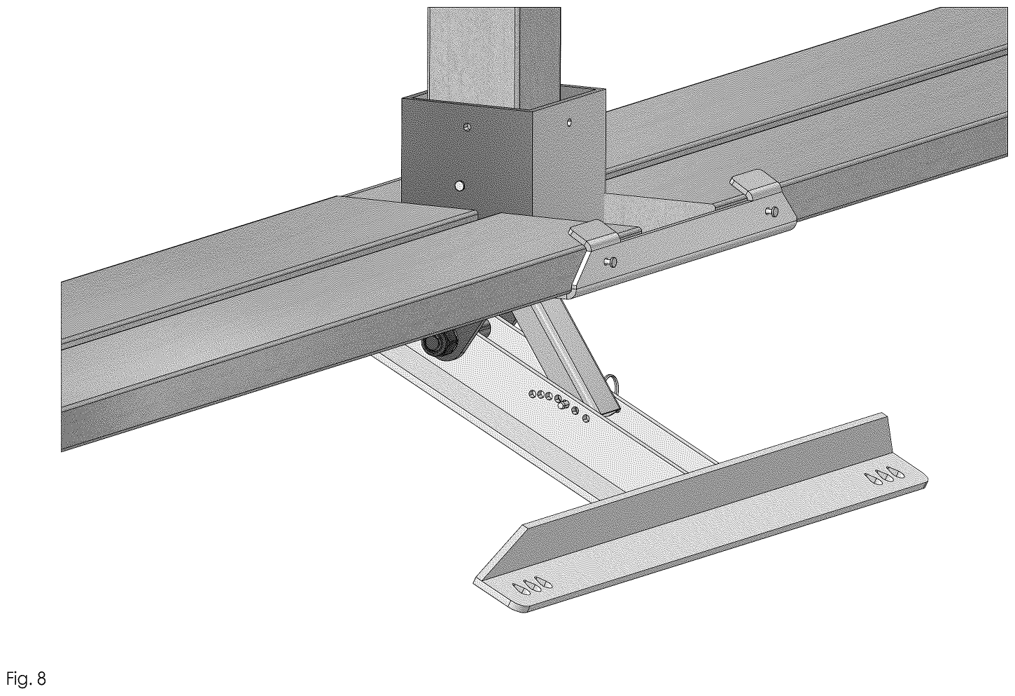

FIG. 8 is an assembled view illustrating the pump jack configuration in its operational state.

### Walking Platform and Guardrail Configuration

The current Continuation-in-Part (CIP) application, pertaining to the “walking plank and guardrail” configuration, omits the 360-degree ladder stop embodiment, FIG. 1(3), the pump jack embodiment, FIG. 1(4), and the sleeved housing embodiment, FIG. 1(7) from the parent non-provisional application titled “Roof Platform—SafetyPitch.” Nonetheless, it retains the core conceptual framework. The present disclosure introduces a base outer frame, FIG. 2(2), incorporating a bolt-cross-bar that is first aligned with the tooth groove selection and then secured using a pin locking system, FIG. 2(3). Additionally, a lower “L” bar embodiment, FIG. 2(4) is included, functioning as an auxiliary truss-mounting component to improve structural stability and facilitate secure attachment to the truss system.

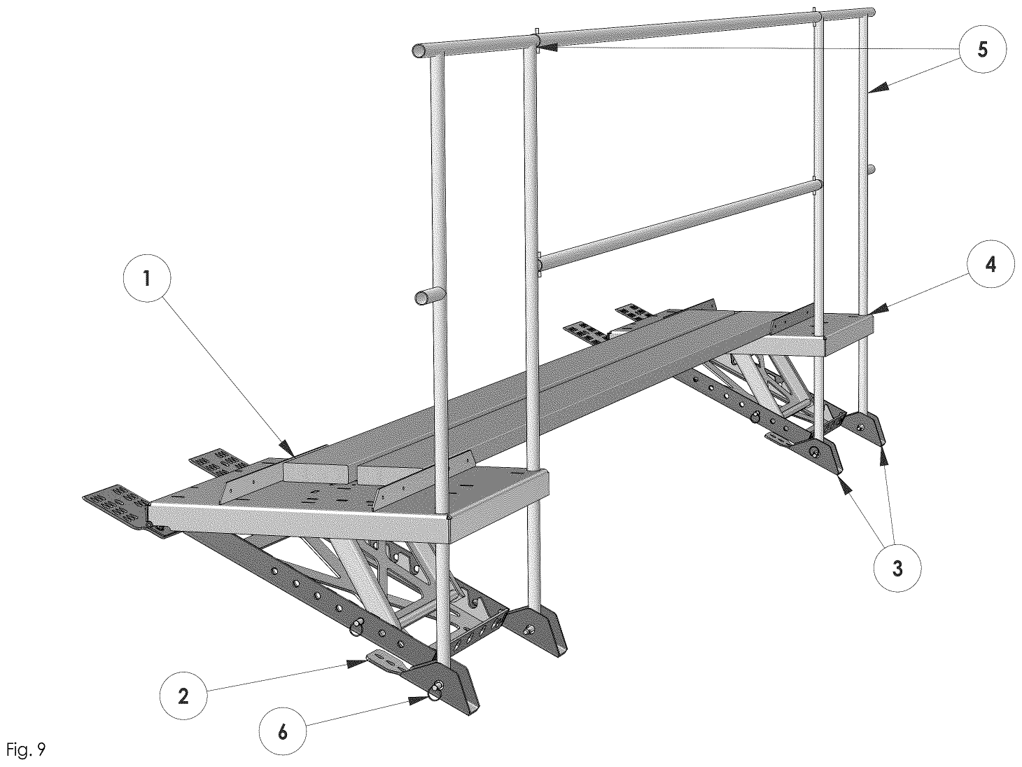

Wood screws are used to secure the unit to the roof trusses via pre-drilled, teardrop-shaped holes, FIG. 3(8) and FIG. 5(1). A level base is established by selecting the appropriate pitch and securing it with a locking mechanism, FIG. 2(3). Walking planks or other walkway structures are affixed to the upper platform using side-positioned, wood screws and upper cleats, FIG. 4(4). Guardrails are then inserted through designated openings in the platform, FIG. 9(4) and positioned into ladder shoes located below, FIG. 9(3). Once the guardrails are lowered into place, they are attached to the ladder shoes and locked using a pin locking mechanism, FIG. 9(6).

What is claimed is:

1: A portable platform designed for high load capacity and horizontal adjustment, configured to provide a level base on inclined surfaces, such as roofs, for anchoring, stabilizing, and securing a ladder during use, comprising and including:
(i). a frame assembly with one or more adjustment points, enabling horizontal leveling across one or more roof pitches or inclined surfaces to create a stable base;
(ii). a 360-degree ladder stop mechanism integrated into the superior surface of the platform structure, allowing the ladder to be positioned and secured in any direction;
(iii). tie-down points featuring integrated drainage slots, providing secure attachment locations for enhanced ladder stability while facilitating drainage to prevent water pooling;
(iv). anchor beds with wood screw attachment points positioned at both the upper and lower sections of the unit, integrated into the frame for secure fastening to roof trusses or similar, structural elements, including but not limited to roof trusses or joists, aligned with multiple, truss spacing;
(v). an adjustable pitch and locking mechanism comprising an inner groove and outer frame assembly for a locking configuration, enabling modification of the platform's angle for precise leveling across multiple pitches or inclined surfaces;
(vi). reinforced, lateral rib members disposed on the inferior surface of the upper platform are configured to facilitate uniform load distribution, thereby enhancing structural integrity and augmenting load-bearing capacity, as delineated in Non-Provisional Utility patent application Ser. No. 18/449,906, filed on Aug. 15, 2023, titled ‘Rooftop Platform—SafetyPitch.’

2: A pump jack scaffolding assembly as a portable platform for high load capacity and horizontal adjustment, configured to provide a stable and level base on roofs or other inclined surfaces for anchoring and supporting scaffolding, comprising and including:
(i). an I-frame assembly with one or more, adjustment points, enabling horizontal leveling across one or more roof pitches;
(ii). an integrated, square, 180 degree, right angle, pump jack housing providing secure support for scaffolding pole and additional components;
(iii). an interchangeable, circular, 360-degree pump jack housing allowing secure support and adjustment of scaffolding pole and additional components;
(iv). “L” bar anchor beds with wood screw attachment points positioned at both the upper and lower sections of the I-frame configuration, designed for secure fastening to roof trusses or similar, structural elements;
(v). An adjustable pitch, locking mechanism integrated into the vertical frame of the I-frame configuration, enabling one or more, modifications of the platform's angle for leveling across multiple, pitched or inclined surfaces;
(vi). anchor beds with wood screw attachment points positioned at both the upper and lower sections of the unit, integrated into the frame for secure fastening to roof trusses or similar, structural elements, including but not limited to roof trusses or joists, aligned with multiple, truss spacing;
(vii). reinforced, lateral rib members disposed on the inferior surface of the upper platform are configured to facilitate uniform load distribution, thereby enhancing structural integrity and augmenting load-bearing capacity, as delineated in Non-Provisional Utility patent application Ser. No. 18/449,906, filed on Aug. 15, 2023, titled ‘Rooftop Platform—SafetyPitch.’

3: A walkway support platform, as a variation of the platform in claim 1, excluding the ladder stop configuration, specifically configured for foot traffic, comprising and including:
(i) parallel plank attachment members with pre-drilled apertures for securing walking planks or walkways via side-mounted wood screws, positioned along the superior surface of the platform, and
(ii). integrated cleat elements positioned at the upper sections of the attachment members to engage the upper surface of the walking planks or walkways, providing structural retention and stability during use;
(iii). a frame assembly with one or more adjustment points, enabling horizontal leveling across one or more roof pitches;
(iv). an integrated guardrail system comprising vertical support poles secured within preformed apertures on the platform, lowered into stabilization shoes, and secured by a locking mechanism;
(v). anchor beds with wood screw attachment points positioned at both the upper and lower sections of the unit for secure fastening/mounting on roof trusses or similar, structures and aligned with multiple, truss spacing;
(vi). an adjustable pitch and locking mechanism configured for modification of the platform's angle across multiple pitches; and
(vii). reinforced, lateral rib members disposed on the inferior surface of the upper platform are configured to facilitate uniform load distribution, thereby enhancing structural integrity and augmenting load-bearing capacity, as delineated in Non-Provisional Utility patent application Ser. No. 18/449,906, filed on Aug. 15, 2023, titled ‘Rooftop Platform—SafetyPitch.’
